(19) United States
(12) Patent Application Publication
(10) Pub. No.: US 2002/0008155 A1
(43) Pub. Date: Jan. 24, 2002

(54) Method and system for hurricane control

(76) Inventor: Herbert Uram, Long Key, FL (US)

Correspondence Address: c/o ANTHONY CASTORINA, SUITE 207, 2001 JEFFERSON DAVIS HIGHWAY, ARLINGTON, VA, 22202, US

(21) Appl. No.: 09/901,717

(22) Filed: Jul. 11, 2001

Related U.S. Application Data
(60) Provisional application No. 60/220,186, filed on Jul. 24, 2000.

(51) Int. Cl. A01G 15/00

(52) U.S. Cl. 239/14.1; 114/312

(57) ABSTRACT

A method and system for inhibiting or weakening the formation of hurricanes, by detecting the onset of a hurricane in a region of open water and immediately cooling the surface water in the open water region. In the decribed preferred embodiments, the surface water is cooled by using one or more nuclear-powered submarines to pump cooler water at a depth in the open water region to the surface of the open water region.

### RELATED APPLICATION

The present application is related to my Provisional Application No. 60/220,186, filed Jul. 24, 2000, and claims the priority date of that application.

### FIELD AND BACKGROUND OF THE INVENTION

The present application relates to a method and system for hurricane control, and particularly to a method and system for inhibiting or weakening the formation of hurricanes.

An average hurricane, or typhoon, has tremendous energy which make it impractical to attempt to modify it by a brute force approach. It is therefore necessary to find a means whereby a relatively small amount of energy, if immediately inputted upon detecting the onset of a hurricane, may be effective to inhibit or at least weaken the formation of the hurricane.

The US Government once supported research into methods of hurricane modification in a project called “Stormfury”. Under this project, scientists seeded clouds with silver iodide in a number of hurricanes including: Esther (1961), Beulah (1963), Debbie (1969), and Ginger (1971). However, these efforts were unsuccessful, and the project was discontinued. Since that time, little if any work for inhibiting or weakening the formation of hurricanes has been reported in the published literature.

Most hurricanes that affect the East Coast of the USA start as “waves” coming off the West African Coast, or in the Gulf of Mexico. It is generally accepted that in those parts of the world where hurricanes or typhoons occur, warming of the seawater is a causative factor. Thus, the warm water, coupled with atmospheric “waves” that come off the West Coast of Africa, unite to start hurricanes in the Atlantic Ocean. While the onset or very early stages of a hurricane can be detected in “real time” on weather satellites, to the present time there has been no practical way by which a relatively small input of energy, upon the detection of the onset of a hurricane, will be effective to inhibit or weaken the formation of the hurricane.

### OBJECTS AND BRIEF SUMMARY OF THE INVENTION

An object of the present invention is to provide a method of inhibiting or weakening the formation of hurricanes. Another object of the invention is to provide a means or system for inhibiting or weakening the formation of hurricanes.

According to one aspect of the present invention, there is provided a method of inhibiting or weakening the formation of hurricanes, comprising: detecting the onset of a hurricane in a region of open water; and immediately cooling the surface water in the open water region.

According to further features in the described preferred embodiments, the surface water is cooled by effecting a heat-transfer of heat between the surface water and the cooler water at a greater depth in the open water region. More particularly, the heat-transfer is effected by pumping the cooler water present at the depth of the open water region to the surface of the open water region. Optionally, the cooler water at the depth of the open water region may be further cooled as it is pumped to the surface of the open water region.

The US Navy has a number of submarines, particularly nuclear-powered submarines, which have been retired from active duty and which could be modified for use to inhibit or weaken the formation of hurricanes in accordance with the present invention. Thus, the use of such submarines would enable implementation of the invention at relatively low cost and at a relatively early date.

According to another aspect of the present invention, therefore, there is provided a submarine for travelling in open water, characterized in that the submarine includes a water pump having an inlet conduit and an outlet conduit; one of the conduits having an open end constructed to be exposed to warm water at the surface of a region of the open water where the onset of a hurricane may be detected; the other of the conduits having an open end constructed to be exposed to cooler water at a depth below the surface of the open water region; the water pump being constructed such that its operation, upon detection of the onset of a hurricane, is effective to utilize the cooler water at the depth of the open water region to cool the water at the surface of the open water region.

Preferably, a plurality of such submarines would be used. In one case, the plurality of submarines could be deployed horizontally over a large area of the open water region where the onset of a hurricane was detected; or they could be deployed vertically at different depths of the open water region with their water pumps coupled to a common vertically-extending water conduit.

The use of submarines, particularly nuclear-powered submarines, for this purpose provides a number of advantages. They are now available, at least those that have become non-operational; they would require relatively little cost and time to retrofit them for this purpose; they can be used for long periods of time without refueling; and they are highly maneuverable so that, if a plurality of disturbances each indicating the possible onset of a hurricane are detected within a short period of time, the submarines can be maneuvered as required to immediately act to inhibit or weaken the formation of the hurricane according to the above-described method.

Further features and advantages of the invention will be apparent from the description below.

### BRIEF DESCRIPTION OF THE DRAWINGS

The invention is herein described, by way of example only, with reference to the accompanying drawings, wherein:

FIG. 1 illustrates one manner of implementing the present invention by the use of a submarine, preferably a nuclear-powered submarine;

FIG. 2 illustrates one manner of using a plurality of such submarines for implementing the invention; and

FIG. 3 illustrates another manner of using a plurality of such submarines for implementing the invention.

### DESCRIPTION OF PREFERRED EMBODIMENTS

As indicated earlier, the present invention inhibits or weakens the formation of hurricanes by cooling the surface water in an open water region immediately upon the detection of the onset of a hurricane in such a region. The onset of hurricanes can be easily detected in real time by satellites. The use of submarines, particularly nuclear-powered submarines, which are presently not operational offers a practical way of cooling the surface water in the open water region immediately upon the detection of the onset of a hurricane in such region.

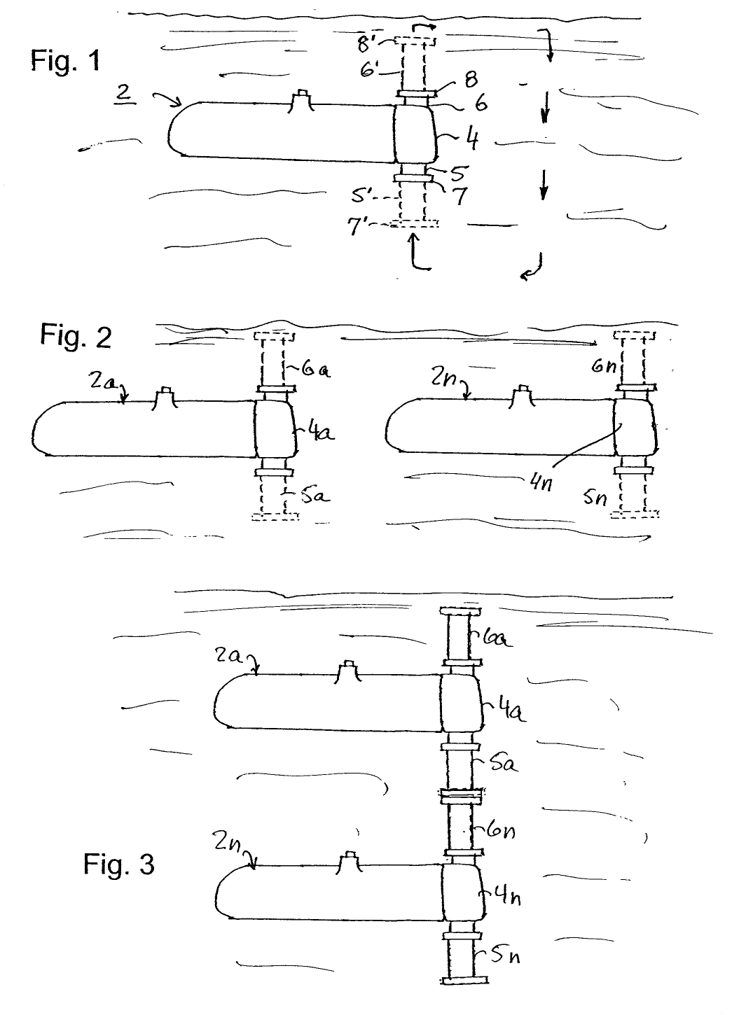

FIG. 1 illustrates such a submarine, generally designated 2, modified to include a water pump 4 having an inlet conduit 5 and an outlet conduit 6. The outlet conduit 6 is constructed so as to have an open end exposed to the warm water at the surface of the region of the open water where the onset of a hurricane is detected; whereas the inlet conduit 5 is constructed so as to have an open end exposed to the cooler water at a depth below the surface of the open water region. Thus, when pump 4 is operated, the cold water is pumped from the water depth to the water surface, thereby cooling the water at the water surface, such that if the onset of a hurricane is detected sufficiently early, the cooling of the surface water may be sufficient to inhibit, or at least weaken, the formation of the hurricane.

The water pump 4 included in the submarine 2 may also be provided with a heat pump or refrigeration unit for further cooling the cold water inletted via conduit 5 and outletted via conduit 6.

The two conduits 5, 6 may be extensible and retractable such that they can be retracted within the submarine to permit its maneuvering to the desired locations, and then extended at the desired location to an operative position (indicated by broken lines in FIG. 1,) for cooling the surface layer of water as described above. In addition, the open end of the lower conduit 5 could be provided with a weight, shown at 7, to enable the open end to descend by its weight to the depth containing the cooler water, as shown by the broken lines 5′, 7′, respectively. Similarly, the open end of the upper conduit 6 could be provided with a float, shown at 8, to enable the open end to float to its operative position adjacent the surface of the open water region, as shown by the broken lines 6′, 8′, respectively. The heat generated by the operation of the water pump 4, or extracted by the operation of a heat pump when included, can be used within the submarine, or can be vented to the water below the submarine, or to the air atmosphere above the submarine.

FIG. 3 illustrates the use of a plurality of such submarines 2a-2n (only two of which are shown) for this purpose, each being constructed as described above in FIG. 1 to provide a water pump 4a-4n (which may also include a heat pump), an inlet conduit 5a-5n, and an outlet conduit 6a-6n. In FIG. 2, the plurality of submarines are deployed horizontally over a large area of the open water region where the onset of a hurricane may be detected.

FIG. 3 also illustrates the use of two (or more) such submarines but deployed vertically at different depths of the open water region, each submarine also being similarly constructed as described above with respect to FIGS. 1 and 2. In this case, however, the conduits of the pumps of the submarines are coupled together to define a common vertically-extending water conduit for pumping the cold water from the depth to the surface of the open water region.

While the invention has been described with respect to several preferred embodiments, it will be appreciated that these are set forth merely for purposes of illustrating the main features of the present invention, and that many variations may be made. For example, a submarine may be provided with more than one pump 4 and appropriate conduits 5, 6, e.g., one at each end, and one or more inbetween. In addition, the warm water at the surface may be cooled by merely pumping it through a refrigeration unit in the submarine. One or more submarines could be equipped with, or modified to serve as, a large refrigeration unit for quickly cooling the surface water. The submarines can also be used to detect conditions, such as water temperatures, wind flow rate, etc., serving as precursors for hurricanes, or early indications of the onset of a hurricane. Many other variations, modifications and applications of the invention will be apparent.

What is claimed is:

1. A method of inhibiting or weakening the formation of hurricanes, comprising:
detecting the onset of a hurricane in a region of open water;
and immediately cooling the surface water in the open water region.

2. The method according to claim 1, wherein the surface water is cooled by effecting a heat-transfer of heat between the surface water and the cooler water at a greater depth in said open water region.

3. The method according to claim 2, wherein said heat-transfer is effected by pumping the cooler water at said depth of the open water region to the surface of said open water region.

4. The method according to claim 3, wherein said cooler water at said depth of the open water region is further cooled as it is pumped to the surface of said open water region.

5. The method according to claim 1, wherein said surface water at the open water region is cooled by at least one submarine.

6. The method according to claim 5, wherein said submarine is a nuclear-powered submarine.

7. The method according to claim 1, wherein said surface water at the open water region is cooled by a plurality of submarines.

8. The method according to claim 7, wherein said plurality of submarines are deployed substantially horizontally over a large area of the open water region.

9. The method according to claim 7, wherein said plurality of submarines are deployed vertically at different depths of said open water region, and their water pumps are coupled to a common vertically-extending water conduit.

10. The method according to claim 1, wherein the onset of a hurricane is detected by a satellite.

11. A submarine for travelling in open water, characterized in that the submarine includes a water pump having an inlet conduit and an outlet conduit;
one of said conduits having an open end constructed to be exposed to warm water at the surface of a region of the open water where the onset of a hurricane may be detected;
the other of said conduits having an open end constructed to be exposed to cooler water at a depth below the surface of the open water region;
said water pump being constructed such that its operation, upon detection of the onset of a hurricane, is effective to utilize the cooler water at said depth of the open water region to cool the water at the surface of the open water region.

12. The submarine according to claim 11, wherein the submarine is a nuclear-powered submarine.

13. The submarine according to claim 11, wherein said submarine also includes a heat pump for further cooling the cooler water at said depth of the open water region as it is pumped to the surface of the open water region.

14. The submarine according to claim 11, wherein said inlet and outlet conduits are extensible from the submarine and retractable within the submarine.

15. The submarine according to claim 11, wherein the open end of said outlet conduit includes a float to enable said open end to float to its operative position adjacent the surface of the open water region.

16. The submarine according to claim 11, wherein the open end of said inlet conduit includes a weight to enable said open end to descend by its weight to said depth containing the cooler water.
